(19) United States
(12) Patent Application Publication
(10) Pub. No.: US 2016/0186683 A1
(43) Pub. Date: Jun. 30, 2016

(54) METHOD AND APPARATUS FOR CONTROLLING INJECTOR DRIVING

(71) Applicant: Hyundai Motor Company, Seoul (KR)

(72) Inventors: Hyung Ju LEE, Yongin-si (KR); Choong Seob PARK, Suwon-si (KR); Ji Haeng LEE, Namyangju-si (KR); Doo Jin JANG, Seoul (KR); Kang Hee CHO, Suwon-si (KR)

(73) Assignee: Hyundai Motor Company, Seoul (KR)

(21) Appl. No.: 14/936,237

(22) Filed: Nov. 9, 2015

(30) Foreign Application Priority Data
Dec. 24, 2014 (KR) 10-2014-0188802

(51) Int. Cl. F02D 41/40; F02D 41/06; F02D 41/34

(52) U.S. Cl. CPC F02D 41/401; F02D 41/345; F02D 41/064

(57) ABSTRACT

A method for controlling a injector driving of the present invention may include the steps of: blocking fuel supply when it is a first start or first ignition-on of a vehicle, driving an injector for a predetermined time; and studying and controlling an opening time of the injector such that the opening time of the injector according to the properties of the injector follows a reference opening time.

### CROSS-REFERENCE TO RELATED APPLICATION

The present application claims priority of Korean Patent Application Number 10-2014-0188802 filed on Dec. 24, 2014, the entire contents of which application are incorporated herein for all purposes by this reference.

### BACKGROUND OF THE INVENTION

1. Field of the Invention

The present invention relates to a method and an apparatus for controlling an injector driving through which exhaust deterioration can be prevented by studying and amending deviation between injectors according to the properties of the injectors before fuel is supplied firstly to the injectors.

2. Description of Related Art

Generally, a fuel control device for a vehicle is a kind of devices for supplying mixed air necessary for combustion to the engine under all of the driving conditions in a most combustible state and the fuel control device is an important component that affects mainly output and efficiency of the engine.

The fuel control device includes a fuel tank, a fuel pump, a fuel filter, a fuel distribution rail assembly, a fuel pressure controller, an injector, various sensors and electronic control units and the like.

Among the components the injector is a device for injecting fuel supplied at a predetermined pressure to a combustion chamber of an engine according to operation signal from an Electronic Control Unit (ECU).

Here, a solenoid valve is embedded in the injector for injecting fuel to a combustion chamber according to a signal transmitted from ECU. That is, when electric current is applied to the coil forming the solenoid valve according to a signal transmitted from ECU, a needle valve is absorbed together with an amateur while a magnetic field is produced around the coil and thus the injector is opened thereby to inject fuel to a combustion chamber of an engine.

Specially, a driving semiconductor needs to be embedded in ECU, which is capable of studying OPEN/CLOSE regions of the injector.

Meanwhile, a deviation of fuel injection amount occurs in the fuel system as described in the forgoing due to a deviation of the injector when a small amount of fuel is injected, and thus pollute substance such as PN is increased due to the deviation of fuel injection amount.

Accordingly, an amendment to the deviation of the injector is necessary as the regulation with respect to air pollution such as PN is tightened up. Specially, since Euro 6+ of a new regulation of exhaust gas will be enforced, advanced automobile industries concentrate on developing technologies capable of meeting with the corresponding regulations.

The essential of Euro 6+ of regulation of exhaust gas relates to the strict standards of Particle Number and the essential technology for decreasing PN relates to a multi injection of fuel.

Here, the multi injection of fuel relates to a technology for injecting a small amount of fuel to engine by dividing a fuel injection time into several times, differently from a technology for injecting a large amount of fuel once to the engine. According to the multi injection of fuel, Particle Number can be decreased comparing to the technology for injecting a large amount of fuel once to an engine.

Meanwhile, since the essential of the multi injection of fuel relates to injecting precisely a smaller amount of fuel than that of a conventional art to an engine within a short time, a precise control of an injector for injecting fuel is needed certainly.

FIG. 1 is a graph illustrating a relation between a fuel injection amount and a fuel injection time of a general injector.

Referring to FIG. 1, in a case of a general injector as the fuel injection time is decreased, the correlation between the fuel injection amount and the fuel injection time represents non-linearity.

When the correlation between the fuel injection amount and the fuel injection time represents non-linearity, precise amount of fuel to be injected cannot be anticipated or controlled. As a result, a technology for compensating the non-linearity needs to be developed certainly.

As a solution for meeting with the above drawbacks, a technology has been proposed for compensating the non-linear property by amending the deviation when an injector drives and perceiving the property variation between injectors and improving response velocity with respect to the deviation compensation thereafter.

Here, a method for confirming the property deviation between injectors may use a factor such as voltage or current and the factor may be used for compensating the property deviation between injectors.

However, the control method of an injector may be used during a general fuel injection procedure, and when an injector is operated firstly after mass production of vehicles, there are intrinsic property differences according to the kinds of the injector or the manufacturing companies and thus there occurs deviation between the injectors.

That is, when an injector is operated firstly, there occur deviations between electrical driving signals and opening and closing operations of the injector according to various factors such as individual property of the injector, that is, injector product distribution, dynamic behavior deviation of a needle valve, driving deviation of an injector, fuel pressure and temperature deviation and the like.

Accordingly, the deviations are continued to a lift amount deviation of a solenoid valve, and when the fuel is injected without considering the lift amount deviation of the valve, the injection amount deviation occurs and thus Particle Matter(PM) and Particle Number (PN) are increased, thereby deteriorating the exhaust.

The description provided above as a related art of the present invention is just for helping in understanding the background of the present invention and should not be construed as being included in the related art known by those skilled in the art.

### BRIEF SUMMARY

The present invention has been proposed to solve the above drawbacks and one object of the present invention relates to provide a method and an apparatus for controlling an injector driving through which exhaust deterioration can be prevented by studying and amending deviation between the injectors according to the properties of the injector before fuel is supplied firstly to the injector.

In one aspect, the present invention provides a method for controlling an injector driving, including the steps of: blocking fuel supply when it is a first start or first ignition-on of a vehicle; driving an injector for a predetermined time; and studying and controlling an opening time of the injector such that the opening time of the injector according to the properties of the injector follows a reference opening time.

The method for controlling an injector driving may further include a step of determining whether the operation of the start or ignition-on of a vehicle is first prior to the blocking step.

When it is determined that the operation of the start or ignition-on of a vehicle is not first in the determining step, it may be controlled that the start or ignition-on of a vehicle is operated by supplying fuel.

The injector may be driven a plurality of times as different driving patterns in the driving step.

The step of studying and controlling may include the steps of; inputting an opening time when the injector is opened while the injector is driven; calculating difference value between the opening time of the injector and a reference opening time based on the same driving time; and amending the opening time of the injector with the calculated difference value to be included to the opening time of the injector.

It may be controlled that the start or ignition-on of a vehicle is operated by supplying fuel after the studying and controlling step.

In another aspect, the present invention provides an apparatus for controlling an injector driving including a controller for blocking the fuel supply, driving the injector for a predetermined time and studying and controlling the opening time of the injector according to the properties thereof to follow the reference opening time when it is a first start or first ignition-on of a vehicle.

### BRIEF DESCRIPTION OF THE DRAWINGS

FIG. 1 is a graph illustrating a relation between a fuel injection amount and a fuel injection time of a general injector;

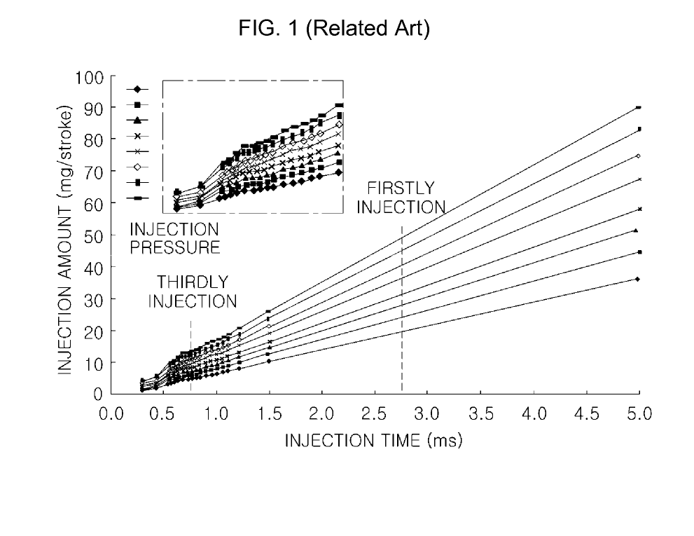

FIG. 2 is a flowchart illustrating a control method of an injector driving according to an embodiment of the present invention; and

FIG. 3 is a view illustrating a studying method of an injector driving studying device according to an embodiment of the present invention.

It should be understood that the appended drawings are not necessarily to scale, presenting a somewhat simplified representation of various preferred features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover the exemplary embodiments as well as various alternatives, modifications, equivalents and other embodiments; which may be included within the spirit and scope of the invention as defined by the appended claims.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items.

Unless otherwise specified, all terms including technical and scientific terms used herein may have the same meanings commonly understandable to those skilled in the art relating to the present invention. In addition, the terms defined in generally used dictionaries are additionally interpreted to have meanings corresponding to related technology literatures and the contents currently disclosed, and are not interpreted either ideally or officially unless clearly specially defined otherwise.

Hereinafter, a method and an apparatus for controlling an injector driving according to preferred examples of the present invention will be described with reference to the accompanying drawings.

A control method of an injector driving of the present invention may include a blocking step S20, a driving step S30 and a studying and controlling step S40.

However, hereinafter, a method will be described for controlling an injector by amending the deviation of the injector according to the properties thereof on the general driving situation and ignition-on situation where fuel is supplied to the injector after an injector is operated firstly, before describing the technical features of the present invention.

For example, a system for amending the deviation according to the properties of an injector may include a Micro Control Unit (MCU), a driving semiconductor and an injector.

In this case, the micro control unit receives an interface signal from the driving semiconductor and produces a control pulse for controlling an injector operation.

Further, the driving semiconductor compensates an injection timing of an injector according to the control pulse that is applied from the micro control unit to output a driving control signal. Further, the driving semiconductor detects and calculates signal representing the driving properties of the injector and reflects the results when compensating the injection timing deviation of the injector. However, it can be controlled that the detecting and calculating of the signal representing the driving properties of the injector is performed in the micro controller not in the driving semiconductor.

The micro control unit and the driving semiconductor may be a micro control unit and a driving semiconductor that have been disclosed in related arts and in addition to them other micro control units and/or the driving semiconductors that are used for controlling the injection timing of an injector may be used.

For example, a controller, which will be described later, may include the micro control unit and the driving semiconductor as an integration controller and in some cases the controller may be included in the micro control unit or the driving semiconductor.

According to the configuration described in the forgoing, the driving semiconductor detects the property of an injector whenever the injector is driven and then controls directly the fuel injection time of the injector in a subsequent injection operation based on the detected information.

Further, the injector injects fuel while the fuel injection timing is compensated according to a driving control signal that is applied to the injector from the driving semiconductor and outputs signal representing the driving properties thereof to the driving semiconductor. At this time, the signal representing the driving properties of an injector may be voltage and current that are consumed when the injector injects fuel and in some cases one of the voltage and current may be selected and used for detecting the driving properties of the injector.

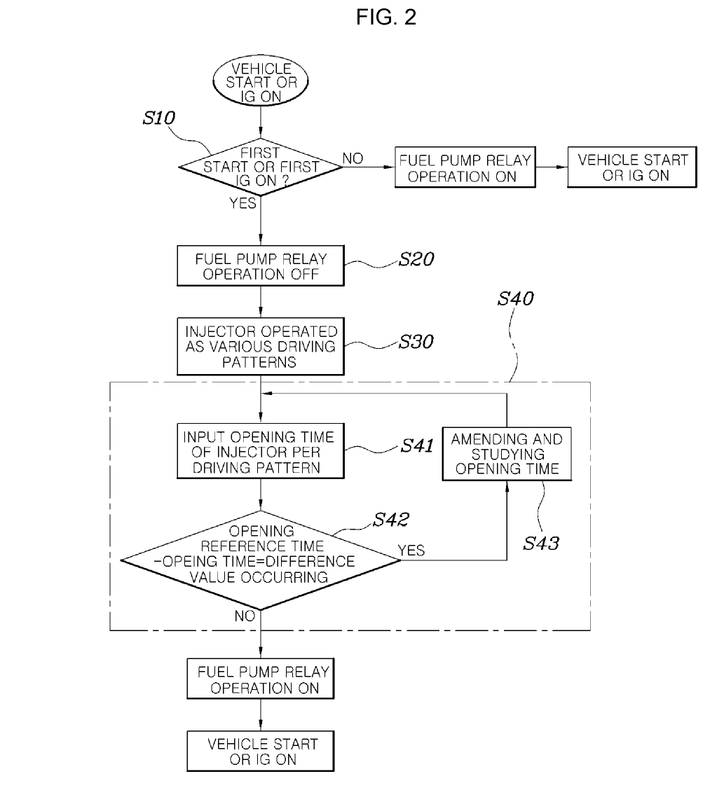

Meanwhile, reviewing in detail technical features of the present invention referring to FIG. 2, firstly the fuel supply is blocked in the blocking step S20 when it is an operation of a first start or a first ignition of a vehicle.

At this time, a determining step S10 for determining whether an operation of a start or an ignition-on of a vehicle is first may be included prior to the blocking step S20.

That is, when it is determined that the operation of the start or ignition-on is first after manufacturing a vehicle, a relay operation of a fuel pump is to be off thereby to block fuel supply to a fuel line and an injector.

Here, whether the operation of the start or ignition-on of a vehicle is first may be determined by the controller 1.

However, when it is determined that the operation of the start or ignition-on of a vehicle is not first in the determining step S10, it can be controlled that the start or ignition-on of a vehicle to be operated by supplying fuel.

For example, the operation of a start or ignition-on of a vehicle is performed normally corresponding to intention of a driver by making a relay operation of a fuel pump to be-on to supply fuel to a fuel line and an injector 3.

Subsequently, when it is determined that the operation of the start or ignition-on of a vehicle is first in the determining step S10 and the fuel supply is blocked, the injector 3 is driven for a predetermined time through the driving step S30.

For example, the injector 3 may be driven a plural of times as different driving patterns in the driving step S30.

That is, an engine is driven at an idle state, a low load state, a middle load state and a high load state according to the driving conditions of a vehicle and the amount of fuel to be controlled properly and injected into a combustion chamber according to the driving conditions. In this case, the driving times of an injector to apply current to a solenoid valve for an opening operation of the injector are different wherein the injector is driven as various driving patterns to which the several driving situations are affected.

Subsequently, the opening time of an injector is studied such that the opening time of the injector according to the properties of the injector 3 follows a reference opening time in the studying and controlling step S40.

In more detail, the studying and controlling step S40 may include an input step S41, a calculating step S42 and an amending step S43.

In the input step S41, an opening time of an injector is input while the injector is driven.

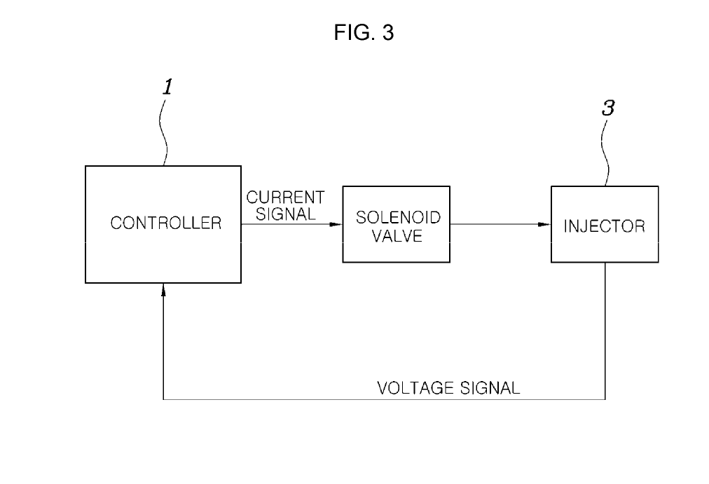

For example, referring to FIG. 3, when electrical signal (current) is applied or released to/from a solenoid valve, an injector is driven to be opened/closed and at this time induced voltage is produced according to behavior of the injector and the produced induced voltage signal is transmitted to a controller 1. Here, the controller 1 measures an opening time of the injector according to the variations of the induced voltage signal.

Subsequently, the difference value between the opening time and the set reference opening time of an injector is calculated in the calculating step S42 based on the same driving time of the injector.

After that, when the difference value occurs in the calculating step S42, the opening time of the injector is amended to include the calculated difference value in the amending step S43.

For example, assuming that the reference opening time is set as 40 ms during a predetermined driving time of an injector, when the practical opening time of the injector is measured as 30 ms during the same driving time of the injector, the opening time of the injector is controlled to be feedback such that the difference value 10 ms is affected to the current opening time of the injector.

Further, according to an exemplary embodiment of the present invention it can be controlled that the start or ignition-on of a vehicle is operated by supplying fuel after the studying and controlling step S40.

For example, fuel is supplied to a fuel line and an injector 3 by making a relay operation of a fuel pump to be-on such that the operations of the start and ignition-on of a vehicle are performed normally corresponding to the intention of a driver.

Meanwhile, an injector driving control device for a vehicle of the present invention may be implemented through a control operation in the controller 1.

In more detail, when it is a first start or first ignition-on the controller 1 blocks the fuel supply, drives the injector 1 for a predetermined time and studies and controls the opening time of the injector according to the properties thereof to follow the reference opening time.

As described in the forgoing, when it is a first start or first ignition-on of a vehicle after manufacturing the vehicle, an injector 3 is driven for a predetermined time (normally one second) without injecting fuel thereby to study an opening time of the injector, thereby preventing the increase of PM and PN due to errors of injection amount of fuel.

Specially, a driving of an injector 3 is studied at an operation section of the injector where fuel is not injected thereby to improve reliability of the studying and further the injector 3 is operated several times to be studied at the same conditions(non fuel injection and same temperature), thereby improving reliability of the studying.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling an injector driving, comprising:
blocking fuel supply when it is a first start or first ignition-on of a vehicle;
driving an injector for a predetermined time; and
studying and controlling an opening time of the injector such that the opening time of the injector according to properties of the injector follows a reference opening time.

2. The method for controlling the injector driving of claim 1, further comprising determining whether operation of start or ignition-on of the vehicle is first prior to the blocking step.

3. The method for controlling the injector driving of claim 2, wherein when the operation of the start or ignition-on of the vehicle is determined to be not first in the determining step, the start or ignition-on of the vehicle is controlled to be operated by supplying fuel.

4. The method for controlling the injector driving of claim 1, wherein the injector is driven a plurality of times as different driving patterns in the driving step.

5. The method for controlling the injector driving of claim 1, wherein the studying and controlling step comprises;
inputting an opening time when the injector is opened while the injector is driven;
determining difference value between the opening time of the injector and a reference opening time based on a same driving time; and
amending the opening time of the injector with the determined difference value to be included to the opening time of the injector.

6. The method for controlling the injector driving of claim 1, wherein the start or ignition-on of the vehicle is controlled to be operated by supplying fuel after the studying and controlling step.

7. An apparatus for controlling an injector driving comprising a controller for blocking a fuel supply, driving the injector for a predetermined time and studying and controlling an opening time of the injector according to properties thereof to follow a reference opening time when it is a first start or first ignition-on of a vehicle.
